(19) United States
(12) Patent Application Publication
(10) Pub. No.: US 2006/0264351 A1
(43) Pub. Date: Nov. 23, 2006

(54) Fabric softening compositions stable under freeze-thaw conditions

(76) Inventors: Hugo Jean Marie Demeyere, Merchtem (BE); Kristof Speltinckx, Rillaar (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/431,871

(22) Filed: May 10, 2006

Related U.S. Application Data
(60) Provisional application No. 60/680,084, filed on May 12, 2005.

(51) Int. Cl. C11D 3/00

(52) U.S. Cl. 510/515

(57) ABSTRACT

Fabric softening compositions comprising a polyol are useful for softening fabric and have a a viscosity below about 500 mPas after a freeze-thaw cycle.

### CROSS REFERENCE TO RELATED APPLICATION

This application claims priority to U.S. Provisional Application Ser. No. 60/680,084, filed May 12, 2005, the disclosure of which is incorporated by reference herein.

### FIELD OF INVENTION

The present invention relates to fabric softening compositions that are stable under freeze-thaw conditions

### BACKGROUND OF THE INVENTION

Conventional liquid fabric softening compositions are in the form of dispersed colloidal particles of the fabric softening compound. Fabric softening compositions formed from dispersed colloidal particles have complex, unstable structures. Because of this instability there are many problems associated with conventional fabric softening compositions. The principal problems are: physical instability at high and low temperatures; when frozen they are converted irreversibly to gels; it is difficult to obtain compositions that exhibit good dispersibility into the wash liquor, deposition onto the fabrics and dispensability from the washing machine dispenser drawer. Poor dispersibility results in uneven coating of fabric softener onto the laundry and in some cases spotting can occur. These problems are exacerbated on the addition of perfume.

Physical instability manifests itself as a thickening on storage of the composition to a level where the composition is no longer pourable, and can even lead to the irreversible formation of a gel. The formation of a gel can also occur in the dispensing drawer of a washing machine when the temperature of the drawer is increased by the influx of warm water. The thickening is very undesirable since the composition can no longer be conveniently used. Physical instability can also manifest itself as phase separation into two or more separate layers.

Products demonstrating good dispersibility and dispensability, and storage stability at low or high temperature are however desired by the consumer.

There is also a need to use solvents that have a high safety profile to minimize any potential health risks.

The present invention attempts to address these and other needs.

### SUMMARY OF THE INVENTION

We have surprisingly found that a fabric softening composition that may address some of the disadvantages of the prior art. The present invention provides fabric softening compositions having excellent softening properties yet which exhibit excellent storage stability at low temperatures, good freeze thaw recovery and excellent dispensability and dispersibility.

One aspect of the invention provides an opaque, rinse-added, fabric softening composition comprising: (a) a fabric softening active comprising from about 5% to about 30% by weight of the composition, and (b) a polyol comprising more than 5% by weight of the composition;

wherein the composition exhibits a viscosity below about 500 mPas after at least one freeze-thaw cycle;

wherein the fabric softening active comprises a compound or a mixture of compounds selected from compounds having the following formula:
{R₄₋ₘ—N⁺—[(CH₂)ₙ—Y—R¹]ₘ}X⁻ (a)
wherein each R substituent is either hydrogen, a short chain C₁-C₆, poly (C₂₋₃ alkoxy), benzyl, or mixtures thereof; each m is 2 or 3; each n is from 1 to about 4; each Y is —O—(O)C— or —C(O)—O; the sum of carbons in each R¹ is C₁₁-C₂₁, with each R¹ being a hydrocarbyl, or substituted hydrocarbyl group; and X- can be any softener-compatible anion; or
{R₄₋ₘ−N⁺−[(CH₂)_{n-Y-R}¹]ₘ}X⁻ (b)
wherein each R substituent is either hydrogen, a short chain C₁-C₆ alkyl, , poly (C₂₋₃ alkoxy), benzyl, or mixtures thereof; each m is 2 or 3; each n is from 1 to about 4; each Y is CH₂, or —NR—C(O)—, or —C(O)—NR— and it is acceptable for each Y to be the same or different; the sum of carbons in each R¹, minus (n+1) when Y is CH2, is C₁₂-C₂₂, with each R¹ being a hydrocarbyl, or substituted hydrocarbyl group; and X⁻ can be any softener-compatible anion; or 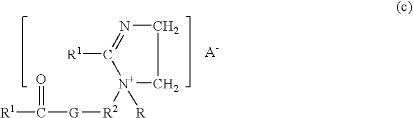
wherein each R, R¹, and A⁻ have the definitions given above; each R² is a C₁₋₆ alkylene group,; and G is an oxygen atom or an —NR— group; and
wherein the polyol is a polyhydric alcohol provided the polyol does not include ethylene glycol, propylene glycol, diethylene glycol, or dipropylene glycol.

Another aspect of the invention provides for a method of softening fabric comprising the step of dosing in a rinse cycle of automatic laundry washing machine a composition of the present invention.

### DETAILED DESCRIPTION OF THE INVENTION

A. Fabric Softener Active

One aspect of the invention provides for fabric softening actives (FSA).

Diester Quaternary Ammonium (DEQA) Compounds

In one embodiment, the fabric softening active comprises a DEQA compound. The DEQA compounds suitable as a fabric softening active in the present compositions include compounds of the formula:
{R₄₋ₘ—N⁺—[(CH₂)ₙ—Y—R¹]ₘ}X⁻
wherein each R substituent is either hydrogen, a short chain C₁-C₆, preferably C₁-C₃ alkyl, e.g., methyl (most preferred), ethyl, propyl and the like, poly (C₂₋₃ alkoxy), preferably polyethoxy, group, benzyl, or mixtures thereof; each m is 2 or 3; each n is from 1 to about 4, preferably 2; each Y is —O—(O)C— or —C(O)—O and it is acceptable for each Y to be the same or different; the sum of carbons in each R¹, is C₁₁-C₂₁, preferably C₁₃-C₁₉, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyidiethanolamine) with fatty acids. Some materials that typically result from such reactions include N,N-di(acyl-oxyethyl)-N,N-dimethylammonium chloride or N,N-di(acyl-oxyethyl)-N,N-dimethylammonium methylsulfate wherein the acyl group is derived from animal fats such as tallow, or vegetable oils such as palm or unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66. Non-limiting examples of preferred diester quats for the present invention include N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC).

Dialkyl Quaternary Ammonium compounds (DQA)

In one embodiment, the FSA Comprises a DQA compound. The DQA compounds suitable as a fabric softening active in the present compositions includes compounds of the formula:
{R₄₋ₘ—N⁺—[(CH₂)ₙ—Y—R¹]ₘ}X⁻
wherein each R substituent is either hydrogen, a short chain C₁-C₆, preferably C₁-C₃ alkyl, e.g., methyl (most preferred), ethyl, propyl and the like, poly (C₂₋₃ alkoxy), preferably polyethoxy, group, benzyl, or mixtures thereof; each m is 2 or 3; each n is from 1 to about 4, preferably 2; each Y is CH₂, or —NR—C(O)—, or —C(O)—NR— and it is acceptable for each Y to be the same or different; the sum of carbons in each R¹, minus (n+1) when Y is CH2, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate.

Imidazolinium Quaternary Compounds

In one embodiment, the FSA comprises a imidazolinium quaternary compound of the following formula: 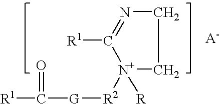
wherein each R, R¹, and A⁻ have the definitions given above; each R² is a C₁₋₆ alkylene group, preferably an ethylene group; and G is an oxygen atom or an —NR— group.

Examples of imidzolinium quaternary compounds include: 1-methyl-1-tallowylamidoethyl-2-oleylimidazolinium methylsulfate and 1-methyl-1-oleylamidoethyl-2-oleylimidazolinium methylsulfate, wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from Degussa under the trade names Varisoft® 475 and Varisoft® 3690, respectively.

Cationic Starch

One aspect of the present invention provides a cationic starch as a FSA.

The term “cationic starch” is used herein in the broadest sense. In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125.

In one embodiment, the compositions of the present invention generally comprise cationic starch at a level of from about 0.1% to about 7%, alternatively from about 0.1% to about 5%, alternatively from about 0.3% to about 3%, alternatively from about 0.5% to about 2%, alternatively from about 0.01% to about 5%, and alternatively from about 0.3% to about 2%, by weight of the composition. Cationic starch is described in U.S. Pat. Pub. 2004/0204337 A1, published Oct. 14, 2004, to Corona et al., at paragraphs 16 - 32.

Sucrose Ester-Based Fabric Care Materials

In one embodiment, the compositions of the present invention may comprise a sucrose ester-based fabric care material is a FSA. A sucrose ester may be composed of a sucrose moiety having one or more of its hydroxyl groups esterified.

Sucrose is a disaccharide having the following formula:

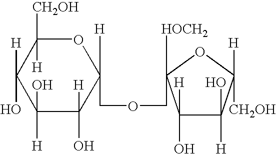

Alternatively, the sucrose molecule can be represented by the formula: M(OH)₈, wherein M is the disaccharide backbone and there are total of 8 hydroxyl groups in the molecule.

Thus, sucrose ester can be represented by the following formula:
M(OH)₈₋ₓ(OC(O)R¹)ₓ
wherein x of the hydroxyl groups are esterified and (8−x) hydroxyl groups remain unchanged; x is an integer selected from 1 to 8, or from 2 to 8, or from 3 to 8, or from 4 to 8; and R¹ mioeties are independently selected from C1-C22 alkyl or C1-C30 alkoxy, linear or branched, cyclic or acyclic, saturated or unsaturated, substituted or unsubstituted.

In one embodiment, the R′ moieties comprise linear alkyl or alkoxy moieties having independently selected and varying chain length. For example, R¹ may comprise a mixture of linear alkyl or alkoxy moieties wherein greater than about 20% of the linear chains are C18, or greater than about 50% of the linear chains are C18, or greater than about 80% of the linear chains are C18.

In another embodiment, the R¹ moieties comprise a mixture of saturate and unsaturated alkyl or alkoxy moieties; the degree of unsaturation can be measured by “Iodine Value” (hereinafter referred as “IV”, as measured by the standard AOCS method). The IV of the sucrose esters suitable for use herein ranges from about 1 to about 150, or from about 2 to about 100, or from about 5 to about 85. The R¹ moieties may be hydrogenated to reduce the degree of unsaturation.

In a further embodiment, the unsaturated R¹ moieties may comprise a mixture of “cis” and “trans” forms about the unsaturated sites. The “cis”/“trans” ratios may range from about 1:1 to about 50:1, or from about 2:1 to about 40:1, or from about 3:1 to about 30:1, or from about 4:1 to about 20:1.

In another embodiment, the composition comprises an olyhydroxy material or sugar derivative. Polyhydroxy amide structures as disclosed in U.S. Pat. No. 5,534,197 by Scheibel et al. and U.S. Pat. No. 5,512,699 by Connor et al.; Pentaerythritol compounds and derivatives as disclosed in U.S. Pat. No. 6,294,516; cyclic polyols and/or reduced saccharides as disclosed in U.S. Pat. No. 6,410,501.

Cationic and Aminosilicones.

One aspect of the present invention provides a cationic or amino functionalized silicones such as those described in U.S. patent application Ser. No. 10/978,942, filed Nov. 1, 2004 (P&G Case 9404); and U.S. Pat. Publ. No. 2005/0026793 A1, Feb. 3, 2005, at paragraphs 137-162.

In one embodiment, the aminosilicones can be linear or branched structured aminosilicone polymers comprised of the following base units:
(R¹R²R³SiO_{1/2})ₚ(R⁴R⁴SiO_{2/2})ₘ[R⁴Si(L—NR⁵R⁶)O_{2/2}]ₐ[Si(K—NR⁷R⁸)O_{3/2}]_{b}[R⁴SiO_{3/2}]_{c}
wherein R¹, R², R³ and R⁴ can independently be (1) C₁-C₂₂ linear or branched, substituted or unsubstituted hydrocarbyl moiety, or (2) —O—R¹¹, —O—R¹², —O—R¹³, and —O—R¹⁴, where R¹¹, R¹², R¹³, and R¹⁴ are H or C₁-C₂₂ linear or branched, substituted or unsubstituted hydrocarbyl moiety.

The nomenclature “SiO_{n/2}” means the ratio of oxygen atoms to silicon atoms, i.e., SiO_{1/2} means one oxygen atom is shared between two silicon atoms. Likewise, SiO_{2/2} means two oxygen atoms are shared between two silicon atoms and, SiO_{3/2} means three oxygen atoms are shared between two silicon atoms.

L and K can independently be C₁-C₂₂ linear or branched, substituted or unsubstituted hydrocarbyl moiety. Preferably L and K are independently C₁-C₁₂ linear or branched, substituted or unsubstituted hydrocarbyl moiety. More preferably L and K are independently C₁-C₄ linear or branched, substituted or unsubstituted hydrocarbyl moiety. Most preferably L and K are independently methylene, ethylene, propylene, 2-methylpropylene, butylene, octadecylene, or 3-(2,2′,6,6′-tetramethyl-4-oxy-piperidyl)propyl.

R⁵, R⁶, R⁷ and R⁸ can independently be H or C₁-C₂₂ linear or branched, substituted or unsubstituted hydrocarbyl moiety, including nitrogen and other heteroatom containing substituent. Preferably R⁵, R⁶, R⁷ and R⁸ are independently H or C₁-C₁₂ linear or branched, substituted or unsubstituted, alkyl or aryl hydrocarbyl moiety, including nitrogen containing substituent and oxygen containing substituent. Most preferably, R⁵, R⁶, R⁷ and R⁸ are independently H, phenyl, cyclohexyl, phenyl, 2-aminoethyl, 2-(N-2-aminoethyl)aminoethyl, 2-[N-2-(N-2-amninoethyl)aminoethyl]aminoethyl, 2-(N-phenyl)aminoethyl, 2-(N-cyclohexyl)aminoethyl, polyethyleneoxide, polypropyleneoxide, polyethyleneoxide-co-polypropyleneoxide, or polyethyleneoxide-co-polypropyleneoxide-co-polyethyleneamine.

Adjunct Fabric Softening Actives

The fabric care compositions of the present invention may comprise adjunct fabric softening actives. These active may include one or more of the following: silicones, including those described in U.S. Pat. Pub. No. 2002/0077265 A1, to Buzzacarini et al., published Jun. 20, 2002 at paragraphs 51-57; clays as described in U.S. Pat. Pub. No. 2004/0142841 A1, published Jul. 22, 2004, to de Buzzacarini et al., from paragraphs 74-99; fats and/or fatty acids U.S. Prov. Appl. No. 60/621,204, filed Nov. 22, 2004 (P&G Case 9812); polyhydroxy amide structures as described in U.S. Pat. No. 5,534,197 by Scheibel et al. and U.S. Pat. No. 5,512,699 by Connor et al.; Pentaerythritol compounds and derivatives thereof as disclosed in U.S. Pat. No. 6,294,516; and cyclic polyols and/or reduced saccharides as disclosed in U.S. Pat. No. 6,410,501.

In one embodiment, the composition of the present invention comprises from about 0.001% to about 10% of an adjunct fabric softening compound. In another embodiment, the compositions are free or essentially free of one the aforementioned adjunct fabric softening actives.

B. Polyols

One aspect of the invention provides for the addition of from about 5% to about 50%, preferably 10% to 35%, more preferably from 15% to 30%, of a polyol by weight of the composition. The present invention is based on the surprising discovery that many polyols can provide commercially acceptable fabric softening compositions that are stable and provide good viscosity at freeze-thaw conditions and have attractive safety profiles. In contrast, polyols such as ethylene glycol, propylene glycol, diethylene glycol and dipropylene glycol may not be as safe as the polyols of the present invention and therefore are specifically excluded. For example, ethyleneglycol is typically found in antifreeze and can be harmful if not fatal if swallowed, while others may be safe but are generally perceived as less desirable given their use in technical applications.

In one embodiment, the polyol of the present invention is a polyhydric alcohol chosen from glycerol, pentaerythritol, hexyleneglycol, glucose, sorbitol, sucrose and the like.

C. Viscosity

One aspect of the invention is based upon the surprising discovery that that the composition of the present invention exhibit commercially acceptable viscosity after a freeze thaw cycle. The term “freeze thaw cycle” means 1 liter of a composition of the present invention is exposed for 24 hrs to −18° C. and is subsequently kept for 24 hrs at +20° C.

In one embodiment, the composition comprises a viscosity after a freeze thaw cycle of below 500, preferably below 200 mPas. For purposes of the present invention, the viscosities of the present compositions are measured at 25° C. with a Brookfield® viscometer using a No. 2 spindle at 60 rpm.

D. Adjunct Materials

One aspect of the invention provides a composition that includes one or more of the following adjunct materials: perfumes, dispersing agents, stabilizers, pH control agents, metal ion control agents, colorants, brighteners, dyes, odor control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and mixtures thereof. These ingredients are described in further detail in EP 1297101 and pending as U.S. patent application Ser. No. 10/925,749 (P&G Case 8079M) and the references cited therein; and U.S. Pat. Appl. Pub. No. US 2003/0060390, to Demeyere, published Mar. 27, 2003, at paragraphs 123-222.

Another aspect of the invention, in the interests of cost savings, provides a composition that is free or essentially free of any one ore more of the above-identified adjunct materials.

As used herein the term “essentially free” means less than 1%, alternatively less than 0.01%, alternatively less than 0.001%, alternatively about 0% of the subject compound, material or ingredient, by weight of the fabric care composition.

E. Methods of Use

The fabric care compositions of the present invention can be used in a so-called rinse process. Typically the compositions of the present invention are added during the rinse cycle of an automatic laundry machine. One aspect of the invention provides dosing the composition of the present invention during the rinse cycle of automatic laundry washing machine. Another aspect of the invention provides for a kit comprising a composition of the present invention and optionally instructions for use.

### F. EXAMPLES

### Example 1

### Compositions of the Present Invention

Examples

| INGREDIENTS | I | II | III | IV |
|---|---|---|---|---|
| DEEDMAC^{a} | 12% | 10% | 10% | 7% |
| Esterfied Sucrose | — | — | — | 1% |
| Glycerol | 30% | 25% | — | 25% |
| Sucrose | — | — | 30% | — |
| Silicone Antifoam^{b} | 0.008% | 0.008% | 0.008% | 0.008% |
| Hydrochloric acid | 0.01% | 0.01% | 0.01% | 0.01% |
| Calcium Chloride | 0.05% | 0.05% | 0.05% | 0.05% |
| Perfume | 0.5% | 0.5% | 0.5% | 0.5% |
| Dye (ppm) | 15 | 15 | 15 | 15 |
| Water | balance | balance | balance | balance |

^{a}DiEthyl Ester DiMethyl Ammonium Chloride in a 15% isoproponal solution.
^{b}MP10 from Dow Corning.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the DETAILED DESCRIPTION OF THE INVENTION are, in relevant part, incorporated herein by reference; the citation of any document is not to be construed as an admission that it is prior art with respect to the present invention

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An opaque, rinse-added, fabric softening composition comprising: (a) a fabric softening active comprising from about 5% to about 30% by weight of the composition, and (b) a polyol comprising more than 5% by weight of the composition;
wherein the composition exhibits a viscosity below about 500 mPas after at least one freeze-thaw cycle;
wherein the fabric softening active comprises a compound or a mixture of compounds selected from compounds having the following formula:
{R₄₋ₘ—N⁺—[(CH₂)ₙ—Y—R¹]ₘ}X⁻ (a)
wherein each R substituent is either hydrogen, a short chain C₁-C₆, poly (C₂₋₃ alkoxy), benzyl, or mixtures thereof; each m is 2 or 3; each n is from 1 to about 4; each Y is —O— (O)C— or —C(O)—O; the sum of carbons in each R¹ is C₁₁-C₂₁, with each R¹ being a hydrocarbyl, or substituted hydrocarbyl group; and X⁻ can be any softener-compatible anion; or
{R₄₋ₘ—N⁺—[(CH₂)ₙ—Y—R¹]ₘ}X⁻ (b)
wherein each R substituent is either hydrogen, a short chain C₁-C₆ alkyl, , poly (C₂₋₃ alkoxy), benzyl, or mixtures thereof; each m is 2 or 3; each n is from 1 to about 4; each Y is CH₂, or —NR—C(O)—, or —C(O)—NR— and it is acceptable for each Y to be the same or different; the sum of carbons in each R¹, minus (n+1) when Y is CH2, is C₁₂-C₂₂, with each R¹ being a hydrocarbyl, or substituted hydrocarbyl group; and X⁻ can be any softener-compatible anion; or
(c) 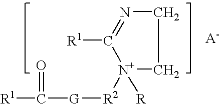
wherein each R, R¹, and A⁻ have the definitions given above; each R² is a C₁₋₆ alkylene group,; and G is an oxygen atom or an —NR— group; and
wherein the polyol is a polyhydric alcohol provided the polyol does not include ethylene glycol, propylene glycol, diethylene glycol, or dipropylene glycol.

2. The composition according to claim 1, further comprising from 0.1% to 10% by weight of the composition of an additional fabric softening active chosen from a hydrophobically modified sugar ester, cationic starch, amino functionalized silicone, or mixture thereof.

3. The composition according to claim 2, wherein fabric softener active is chosen from N,N-di(hydrogenated tallowoyloxyethyl)-N,N-dimethylammonium chloride; N,N-di(tallowoyloxyethyl)-N,N-dimethylammonium chloride; Di-hydrogenated tallow dimethyl ammonium chloride or ditallowdimethyl ammonium chloride; 1-methyl-1-tallowylamidoethyl-2-oleylimidazolinium methylsulfate; 1-methyl-1-oleylamidoethyl-2-oleylimidazolinium methylsulfate; mixture thereof.

4. The composition according to claim 3, which after undergoing at least two freeze/-thaw cycles, exhibits a viscosity not higher than 500 mPas, preferably not higher than 200 mPas.

5. The composition according to any one of claim 4, wherein the polyol is selected from glycerol, pentaerythritol, glucose, fructose, sucrose, and maltose.

6. The composition according to any one of claim 5, wherein the polyol comprises from between 5% to 50%, preferably from 10% to 35%, and most preferably from 15% to 30% by weight of the composition

7. The composition claim 6, wherein the polyol is glycerol.

8. The composition of claim 7, wherein the level of glycerol is at least 15% by weight of the composition.

9. The composition according to claim 6, wherein the polyol is a sugar.

10. A method of softening fabric comprising the step of dosing in a rinse cycle of automatic laundry washing machine a composition according to claims 1.
